(19) United States
(12) Patent Application Publication
(10) Pub. No.: US 2009/0043634 A1
(43) Pub. Date: Feb. 12, 2009

(54) Worker Adaptive Task management and Workflow System

(75) Inventor: Julie H. Tisdale, Salt Lake, UT (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/033,216

(22) Filed: Feb. 19, 2008

Related U.S. Application Data
(60) Provisional application No. 60/954,073, filed on Aug. 6, 2007.

(51) Int. Cl. G06F 17/30

(52) U.S. Cl. 705/9

(57) ABSTRACT

A system provides a daily workflow list that is tailored according to nurse tenure, experience, specialty, licensure and education, for example. An adaptive healthcare workflow and task management system includes a repository of first information indicating clinician tasks and related subtasks for performance by a clinician in providing a particular care service to a patient. The system includes a repository of second information indicating experience and qualifications of multiple different clinicians. A rules processor, in response to a particular clinician identifier and data identifying a clinician task to be performed by the particular clinician in providing a particular care service to a patient, employs the first and second information in adaptively determining a subtask related to the clinician task to be indicated to be performed by the particular clinician based on experience and qualifications of the particular clinician. An output processor provides data for reproduction and presentation to the particular clinician indicating the subtask related to the clinician task to be indicated to be performed by the particular clinician.

A Worker Adaptive Task management and Workflow System This is a non-provisional application of provisional application Ser. No. 60/954,073 filed Aug. 6, 2007, by J. H. Tisdale.

### FIELD OF THE INVENTION

This invention concerns a system for adaptively determining subtasks of a clinician task, to be performed by the clinician, based on experience and qualifications of the clinician.

### BACKGROUND OF THE INVENTION

A nurse starting a work shift needs to quickly assimilate specific tasks ordered by physicians such as administering a pain medication or changing a dressing and also needs to be aware of treatment protocols or subtasks associated with such orders. This is a large amount of information that is difficult to assimilate in a short period of time, especially for a nurse new to the profession, a hospital facility, or a hospital floor. Subtasks may be performed late or have been overlooked completely, out of ignorance or ineffective time management. An inexperienced nurse is not immediately able to mentally keep track of when to change a bag of continuous bladder irrigation fluid, or realize that a dressing change and medication administration could be combined into one visit to a patient room, or that a patient scheduled for an EGD (esophagogastroduodenoscopy) should consume nothing by mouth 6-12 hours before the procedure, for example. This may result in a nurse making multiple trips to a supply room, waking patients unnecessarily, missing performance of a task completely, rescheduling of procedures and may potentially result in patient neglect or harm.

Known electronic nurse worklists (as used herein comprises task lists) merely list tasks at face value such as to administer a medication, change a dressing, send a patient for an EGD and fail to contemplate associated subtasks. Consequently, a nurse without the benefit of prior experience, is responsible for managing tasks unaided within the context of a shift, hospital treatment protocol, and profession. Inexperienced nurses also do not have a background to effectively comprehensively understand implications of tasks and need to rely on experience and/or memory which is subject to quality and productivity lapses. Known systems do not account for the varying skill and experience level of nursing staff and other clinicians and workers. These systems assume that providing a standard worklist containing patient orders provides sufficient information for nurses, regardless of background, length in the profession, current experience, specialty, and tenure with the organization. Known systems lack the ability to personalize a worklist according to needs of an individual nurse. Listing the tasks for an experienced nurse is often enough, however, for a novice or new nurse such a list fails to provide a cognitive road map from which to plan patient care. Work shift time management is learned through trial and error and emulating experienced nurses. This process takes time and can negatively impact the level of patient care provided. A system according to invention principles addresses these deficiencies and related problems.

### SUMMARY OF THE INVENTION

A system provides a daily workflow list that is tailored according to nurse tenure, experience, specialty, licensure and education, for example, that guides a nurse through tasks to be accomplished in a work shift. An adaptive healthcare workflow and task management system includes a repository of first information indicating clinician tasks and related subtasks for performance by a clinician in providing a particular care service to a patient. The system includes a repository of second information indicating experience and qualifications of multiple different clinicians. A rules processor, in response to a particular clinician identifier and data identifying a clinician task to be performed by the particular clinician in providing a particular care service to a patient, employs the first and second information in adaptively determining a subtask related to the clinician task to be indicated to be performed by the particular clinician based on experience and qualifications of the particular clinician. An output processor provides data for reproduction and presentation to the particular clinician indicating the subtask related to the clinician task to be indicated to be performed by the particular clinician.

### BRIEF DESCRIPTION OF THE DRAWING

FIG. 1 shows an adaptive healthcare workflow and task management system, according to invention principles.

FIG. 2 shows a table of categories of clinician characteristics, according to invention principles.

FIG. 3 shows a table of clinician performance related statistics, according to invention principles.

FIG. 4 shows a table of data associating a treatment, task description and subtask level, according to invention principles.

FIG. 5 shows rules employed by a rules processor used by an adaptive healthcare workflow and task management system, according to invention principles.

FIGS. 6, 7 and 8 show a nurse worklist dynamically provided by an adaptive healthcare workflow and task management system, according to invention principles.

FIG. 9 shows an adaptive healthcare workflow and task management system and process for dynamically providing a nurse worklist, according to invention principles.

FIG. 10 shows a flowchart of a process performed by an adaptive healthcare workflow and task management system, according to invention principles.

### DETAILED DESCRIPTION OF THE INVENTION

A nurse's normal workday is often neither normal nor predictable. On any given day there may be a great number of tasks and hundreds of items of accompanying information that a nurse needs to juggle with much of that information being carried in the memory of a nurse. An experienced nurse has learned through years of practice to intuitively track and schedule tasks competently and efficiently. On the other hand, an inexperienced nurse spends many months learning not only the nursing profession, but how to structure the work that needs to be done in a shift while not jeopardizing patient care. A system provides a daily workflow list (worklist) that guides a nurse through the tasks to be accomplished in a shift and enables the content of the worklist to be tailored according to nurse tenure, experience, specialty, licensure and education, for example. These characteristics have a direct impact on nurse productivity and the quality of patient care.

A Nurse Dynamic Worklist system according to invention principles, supports nursing workflow within a framework of a specific nursing shift. The system automatically generates a worklist (task list) at the beginning of (or any time during) a work shift to capture outstanding nursing duties to be performed for a selected patient, such as medication administration, continuous running IV (Intra-Venous) infusions, dressing changes, X-rays, bladder irrigations, etc. The detail level of the worklist is automatically adapted according to the personal individual profile of a nurse. If a nurse is scheduled to administer pain medication, the worklist may include a subtask to reassess patient pain level 20 minutes after administration. If a nurse is scheduled to hang continuous bladder irrigation, the worklist may add a subtask to a list to initiate a nurse to hang a new bag of solution at the appropriate time. Adding subtasks to an inexperienced nurse worklist aids with time management and contributes to increased quality of patient care. Although, the system is described herein in the context of adaptive nurse worklists, this is exemplary only. The system is equally applicable to providing adaptive worklists for other clinicians, healthcare workers and workers in general.

Known electronic nurse worklists do not provide for subtasks to be included with a task ordered by a physician, for example. In contrast, the system provides electronic coaching for a nurse to ensure work performance is of high quality and provides electronic help to prevent missed or incorrect actions and improve productivity. Assisting nurses with improved workflows (task sequences) aids in delaying or preventing nurse work related “burn out” which is, unfortunately, not uncommon. The system provides a worklist that provides a personalized listing of physician ordered tasks for each patient, as well as intuitive or procedural subtasks. The dynamic worklist comprises a user interface image window including a time grid to quickly provide information indicating subtasks related to scheduled nursing workflow tasks. Displayed subtask information includes, for example, showing at a glance what tasks can be combined in a single trip to a patient bedside, alerting a nurse when infusion or irrigation bags need to be changed, notifying a nurse of pre-procedure protocol, such as nothing by mouth after midnight and reminding a nurse to reassess patient pain level after administering pain medication. These subtasks are dynamic in that they are indicated in a report or display image or are suppressed, depending on the personal profile of a nurse. If the nurse is experienced and has worked in a facility or specialty for some time, the system adaptively omits subtasks from the shift worklist. However, if the nurse is a new graduate, has come from a different healthcare system, or has been out of the workforce for some time, the system includes the subtasks to help with time management and ensure that patient care is delivered efficiently and improve outcomes and quality.

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor may comprise a combination of, hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

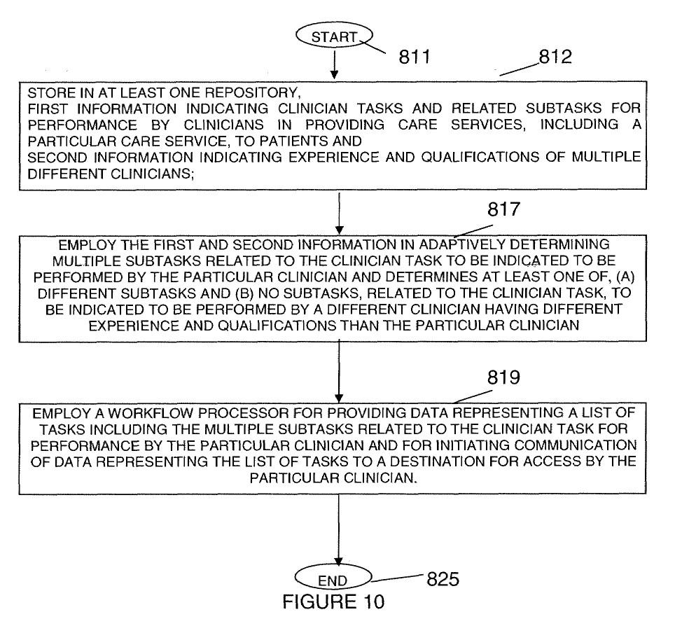

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps (e.g., of FIG. 10) herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure.

A workflow processor, as used herein, processes data to determine tasks to add to a task list, remove from a task list or modifies tasks incorporated on, or for incorporation on, a task list. A task list is a list of tasks for performance by a worker or device or a combination of both. A workflow processor may or may not employ a workflow engine. A workflow engine, as used herein, is a processor executing in response to predetermined process definitions that implement processes responsive to events and event associated data. The workflow engine implements processes in sequence and/or concurrently, responsive to event associated data to determine tasks for performance by a device and or worker and for updating task lists of a device and a worker to include determined tasks. A process definition is definable by a user and comprises a sequence of process steps including one or more, of start, wait, decision and task allocation steps for performance by a device and or worker, for example. An event is an occurrence affecting operation of a process implemented using a process definition.

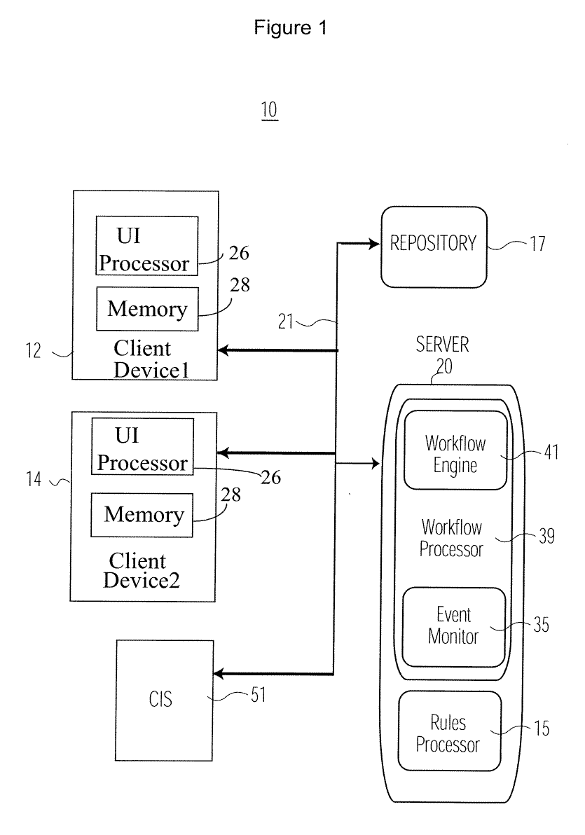

FIG. 1 shows an adaptive healthcare workflow and task management system 10 for providing a user with a daily worklist adapted according to nurse tenure, experience, specialty, licensure and education, for example. The worklist guides a nurse through tasks to be accomplished in a shift. System 10 includes client devices (e.g. workstations, Personal Digital Assistants, cell phones) 12 and 14, at least one repository 17, Clinical Information System (CIS) 51 and server 20 inter-communicating via network 21. Server 20 includes rules processor 15 and workflow processor 39 including event monitor 35 and workflow engine 41. Client devices 12 and 14 individually include memory 28 and display processor 26. Display processor 26 provides data representing display images for presentation on client device 12 and 14.

At least one repository 17 includes a repository of first information and a repository of second information. The first information indicates clinician tasks and related subtasks for performance by clinicians in providing care services, including a particular care service, to patients, and subtasks of an individual task are hierarchically arranged into different categories. The second information indicates experience and qualifications of multiple different clinicians. Rules processor 15, in response to a particular clinician identifier and data identifying a clinician task to be performed by the particular clinician in providing a particular care service to a patient, employs the first and second information in adaptively determining a category of subtask based on experience and qualifications of the particular clinician. Workflow processor 39 provides data representing a list of tasks (e.g., a Nurse's Dynamic Worklist) including subtasks of a determined category of subtasks related to the clinician task for performance by the particular clinician and initiates communication of data representing the list of tasks to a destination for access by the particular clinician.

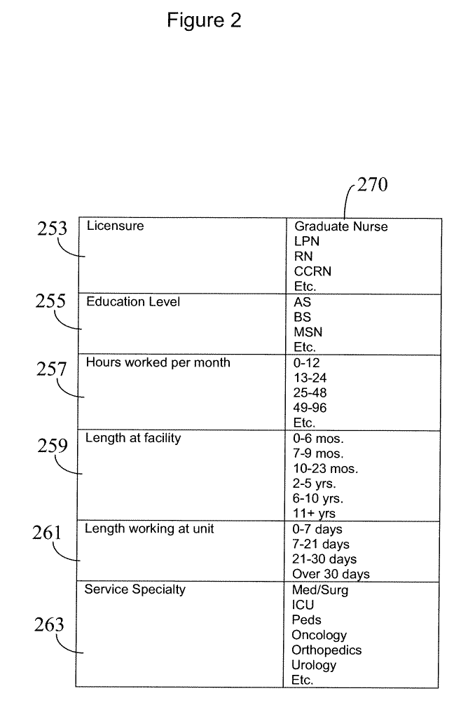

FIG. 2 shows a table of categories of clinician characteristics stored by system 10 in at least one repository 17 and used in establishing a clinician (e.g., a nurse) skill, education, experience and license profile. In order to generate a personalized Nurse's Dynamic Worklist, individual nurse data is organized into categories. The categories include licensure 253, education level 255, hours worked per month 257, length of time spent working at a hospital facility 259, length of time working in a particular care unit 261 and service specialty 263. Corresponding values and value ranges (sub-categories) for individual categories are indicated in column 270. For example, licensure category 253 comprises values including graduate nurse, LPN (licensed professional nurse), RN (registered nurse), CCRN (critical care registered nurse). Data collected compatible with the individual categories may be used in any number of combinations depending on the needs of an individual specific hospital (or other medical) facility.

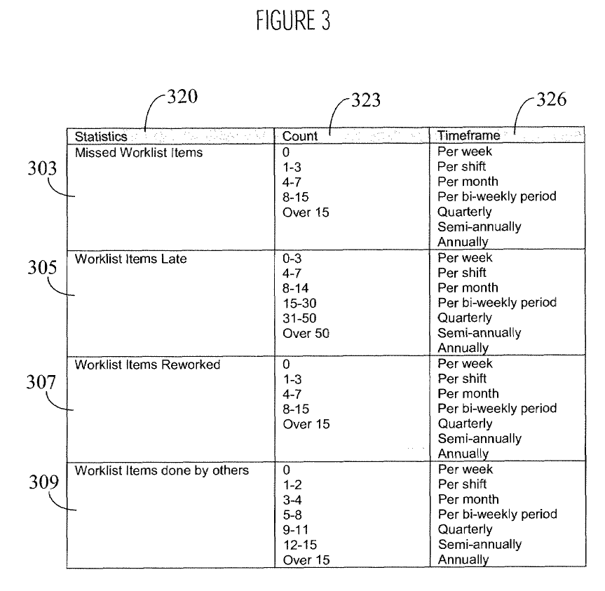

In addition to the specific background and historical and demographic information maintained in a clinician profile as illustrated in FIG. 2, statistics are stored by system 10 in repository 17 concerning individual clinician performance. FIG. 3 shows a table of stored clinician performance related statistics in column 320, an associated corresponding count value range in column 323 and an associated time period in column 326. Clinician performance related statistics in column 320 include missed worklist (task) items 303 i.e., worklist items not performed, worklist items performed late 305, worklist items requiring rework 307 and worklist items performed by others 309. The number of missed worklist items 303 are identified by range in column 320 (e.g., 0, 1-3, 4-7, 8-15 and over 15) that occur in a time period indicated in column 326 (e.g., per week, shift, month, bi-weekly, quarterly, semi-annually and annually), for example. The performance factors in the table of FIG. 3 are also used to determine the level of subtask tracking and monitoring to be performed for an individual clinician. A subtask comprises an individual task of a set of tasks involved in performing a treatment service or procedure. The threshold limits used to determine the subtask levels are defined by a hospital facility, location and supervisor, for example. The statistics are kept on a rolling basis so that as improvements in performance are noted, corresponding changes in the subtask levels are made.

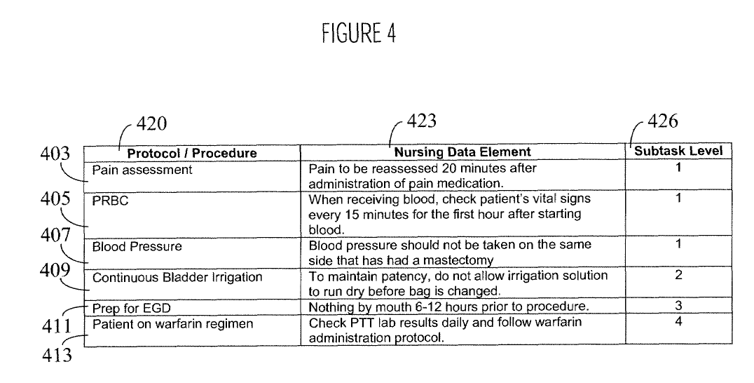

FIG. 4 shows a table of data associating a treatment, task description and subtask level stored by system 10 (FIG. 1) in repository 17. Workflow processor 39 provides data representing a Nurse's Dynamic Worklist (list of tasks) that incorporates data elements indicating specified treatment protocols and procedures, and assigns a corresponding notification level for each subtask. This value is user defined and rules processor 15 adaptively determines when a subtask is included in a Nurse's Dynamic Worklist. The FIG. 4 table includes treatment protocol or procedure in column 420, an associated nursing data task description in column 423 and an associated subtask level in column 426. The treatment protocol or procedure in column 420 includes pain assessment 403, PRBC (packed red blood count) 405, blood pressure 407, continuous bladder irrigation 409, preparation for EGD (Esophagogastroduodenoscopy) 411 and patient warfarin regimen 413. The pain assessment treatment protocol 403, for example, is associated with, nursing data task description in column 423 indicating pain is to be reassessed 20 minutes after administration of pain medication and with a subtask level (value of 1) in column 426.

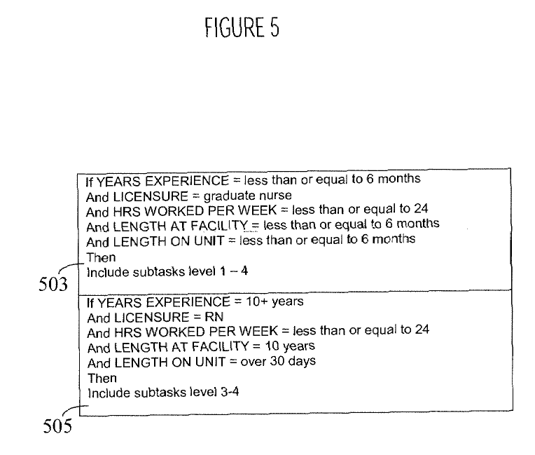

FIG. 5 shows rules employed by rules processor 15 (FIG. 1) used by adaptive healthcare workflow and task management system 10. Rules processor 15 analyzes a nurse personal profile (e.g., as illustrated in FIGS. 2 and 3) to establish a skill and experience level. The established nurse skill and experience level determines which level of subtasks (e.g., as indicated in column 426 of FIG. 4) appear in the Nurse's Dynamic Worklist. Rules processor 15 executes rules 503 and 505 (FIG. 5) to adaptively determine the level of subtasks to add to a nurse dynamic worklist. Specifically, rules processor 15 executes rule 503 and includes subtasks level 1-4 if, a nurses years experience=less than or equal to 6 months AND licensure=graduate nurse AND hrs worked per week=less than or equal to 24 AND length at facility=less than or equal to 6 months AND length on unit=less than or equal to 6 months. Rules processor 15 executes rule 505 and includes subtasks level 3-4 if, years experience=10+ years AND licensure=RN AND hrs worked per week=less than or equal to 24 AND length at facility=10 years AND length on unit=over 30 days.

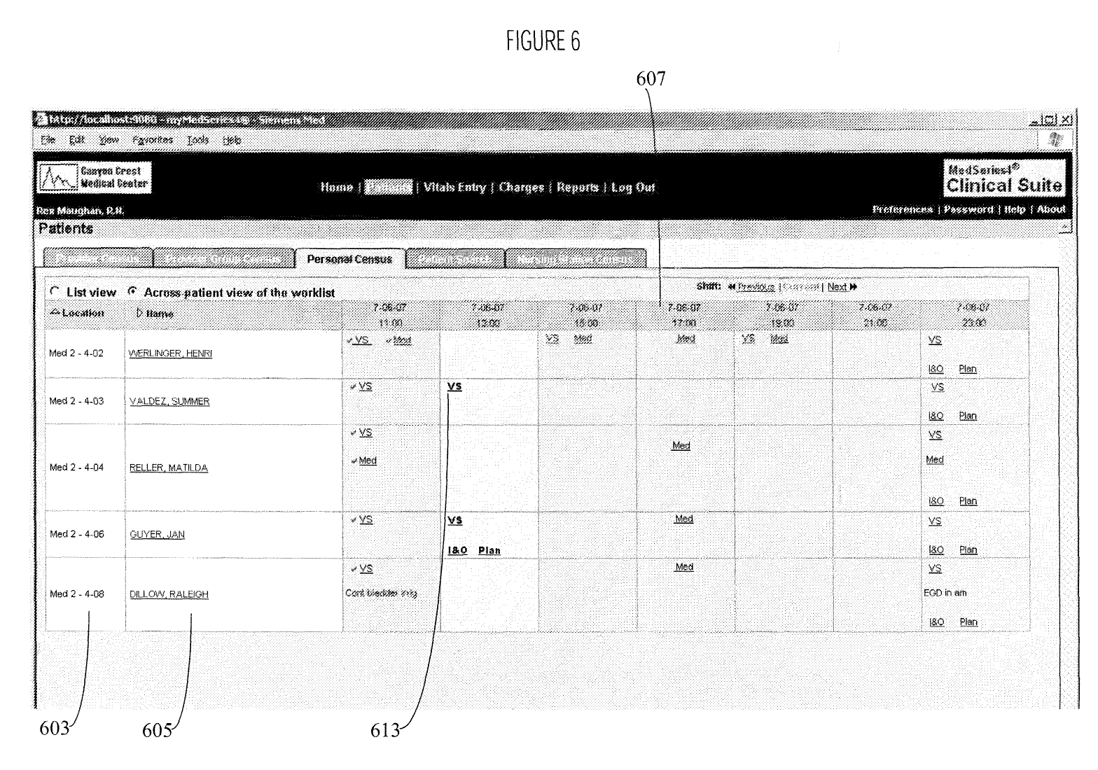

FIGS. 6, 7 and 8 show nurse worklists dynamically provided by adaptive healthcare workflow and task management system 10. A worklist shows tasks organized by patient and lists the tasks to be accomplished chronologically throughout a work shift. In the FIG. 6 nurse worklist, Location column 603 displays data indicating the location of a patient in a hospital, i.e., floor and bed. Name column 605 displays patient name. Work shift window area 607 indicates current work shift scheduled activities for a nurse in 2 hour increments along a timeline and includes the last two hours of a previous shift. Work shift window area 607 indicates individual scheduled tasks in respective two hour increment columns and in response to user selection of a link item indicating a task to be performed, such as vital sign acquisition task link 613 (VS), detailed information concerning the task is displayed.

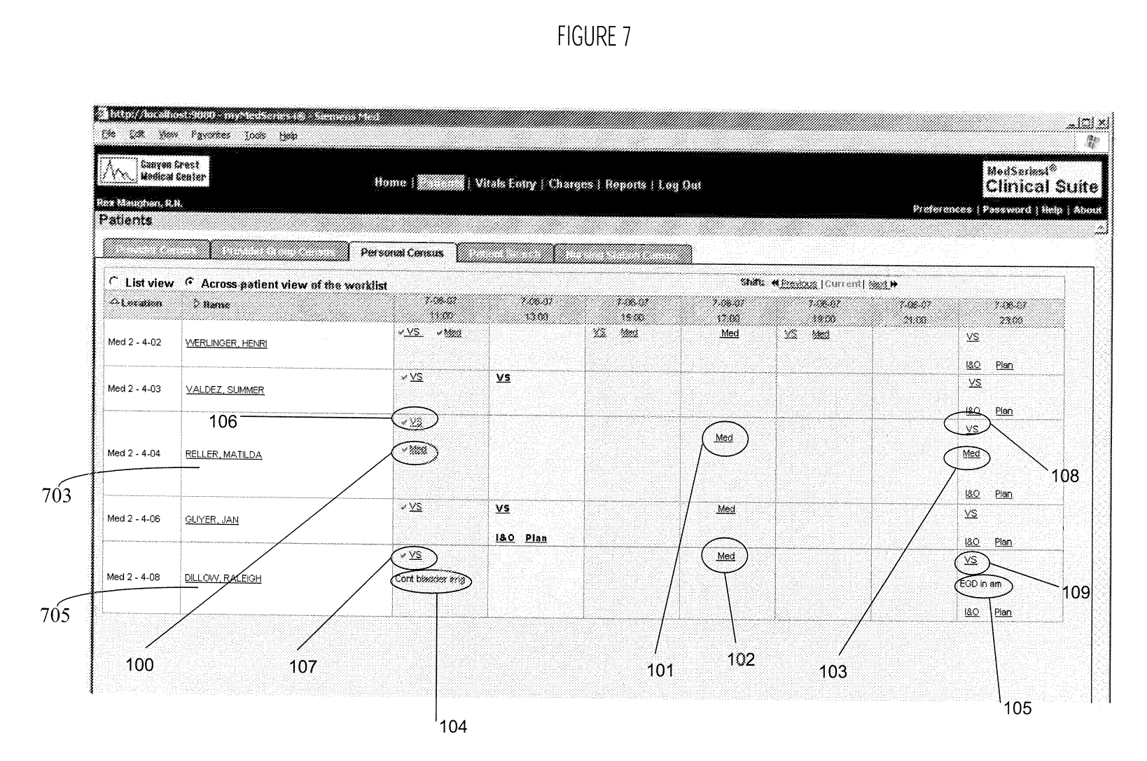

In response to execution of rules for processing acquired nurse profile information, workflow processor 39 generates a Nurse's Dynamic Worklist that displays a personalized nurse specific task schedule tailored according to an individual nurse's skill level, education, experience and licenses. In illustration two patients are considered. In the FIG. 7 nurse worklist, a first patient 703 (Matilda Reller) has had a mastectomy on her right side, and has received a doctor's orders for Morphine 2 mg IV every 6 hrs and Vital Signs to be taken every 4 hours. A second patient 705 (Raleigh Dillow) has received doctor's orders for continuous bladder irrigation and EGD to be performed in the morning. The two patients have been assigned to an experienced first nurse who has been working on a care unit for some time. The first nurse needs nothing more on the worklist than primary tasks of medication administration (100, 101, 102 and 103), notice that the bladder should be irrigated (104), an EGD task (105), and tasks to acquire vital signs frequency (106, 107, 108 and 109).

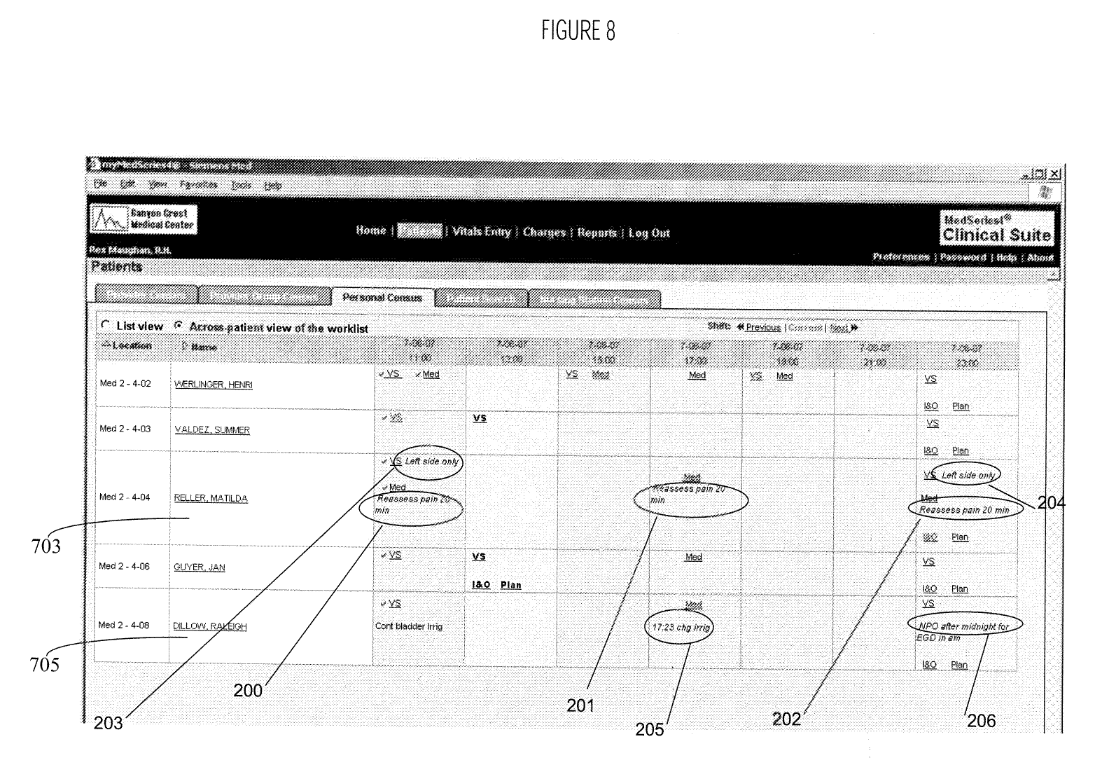

The Nurse Dynamic Worklist of FIG. 8 illustrates the first and second patients (703 and 705) being assigned to a newly hired inexperienced second nurse (an RN), that has only had a license for 60 days. In addition to the primary tasks on the worklist (tasks 100-109 of the worklist of FIG. 7), the second nurse benefits from having subtasks added to the worklist. The added subtasks aid the second nurse in remembering that after administering first patient 703 pain medication, the pain level is to be reassessed in 20 minutes (tasks 200, 201 and 202). The added subtasks indicate blood pressure of first patient 703 is to be taken on the left arm because the patient has had a right side mastectomy (tasks 203 and 204). The added subtasks further indicate the bladder irrigation fluid of second patient 705 is due to run out at approximately 1700 hours. Further, the fluid is to be changed before it runs out in order to prevent a break in the flow, which may lead to decreased catheter patency or occlusion (task 205). In addition subtask 206 indicates second patient 705 is to have nothing by mouth after midnight in order to prepare for his morning EGD. Therefore, rules processor 15, operating in conjunction with workflow processor 39, adaptively generates different Nurse's Dynamic Worklists for the first and second nurse, even though they are caring for the same patients.

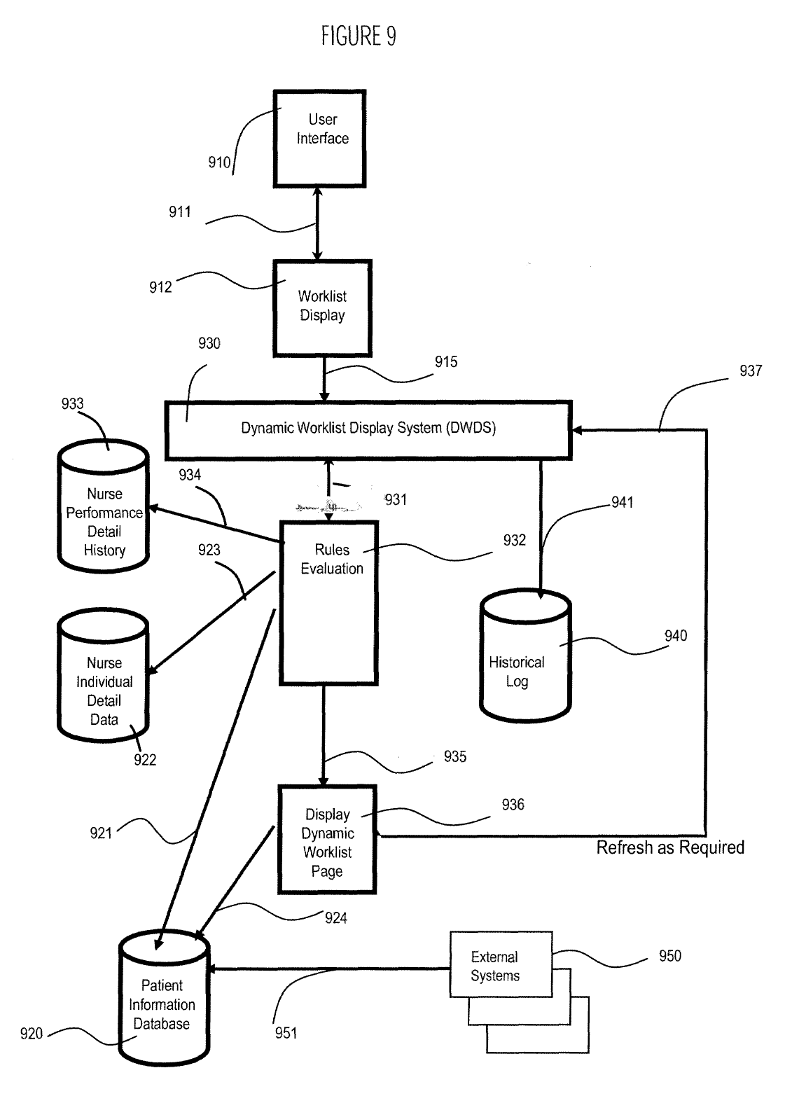

FIG. 9 shows an adaptive healthcare workflow and task management system and process for dynamically providing a nurse worklist. A user interacts with a Nurse's Dynamic Worklist through user interface 910 which is provided by worklist display 912 through interface 911. Worklist display 912 interfaces with Dynamic Worklist Display System (DWDS) 930 through communication link 915. Dynamic Worklist Display System (DWDS) 930 employs rules evaluation subsystem 932 via link 931. Rules Evaluation subsystem 932 acquires current and historical information (nurse tenure, experience, specialty, licensure and education information) concerning a current nurse (or clinician) from Nurse Performance Detail History 933 through link 934. Subsystem 932 acquires patient information from Patient Information Database 920 through link 921 for a current patient selected in response to Nurse Individual Detail Data 922 determined through link 923. Patient data acquired from external systems 950 via link 951 is stored in Patient Information Database 920 using a variety of different known integration methods, (e.g., push, pull, intermittent update).

Data indicating transactions and activities performed by Dynamic Worklist Display System 930 is stored in historical log 940 through link 941. This historical data is used for, documentation of compliance with governmental regulations, such as HIPAA, quality control or internal human resource management and control. In response to completion of execution of rules by Rules Evaluation subsystem 932, results of the rules execution are merged into a displayed dynamic worklist page 936 through interface 935 and stored in patient information database 920 via link 924. Displayed Dynamic Worklist Page 936 includes standard worklist items associated with orders for administration of treatment, care plan activities, nursing activities, physician activities compliant with hospital and facility procedures. Dynamic subtask content derived by Rules Evaluation subsystem 932 is merged into Displayed Dynamic Worklist Page 936 to provide data content and subtask levels of assistance required based on nurse education and skill level, experience, familiarity with environment and facility preferences. As new tasks are added, changed or removed from a dynamic worklist by a user or by other users of the system, Displayed Dynamic Worklist Page 936 is refreshed 937 as required by Dynamic Worklist Display System 930. In response to refresh of Displayed Dynamic Worklist Page 936, a new execution of Dynamic Worklist Display System 930 is initiated since a single change in a worklist item may result in changes to many of the items displayed on Dynamic Worklist Page 936.

Adaptive healthcare workflow and task management system 10 adapts a work shift worklist to the needs of a specific nurse by including follow on, or related subtasks, to provide an enhanced worklist. System 10 decreases errors, increases efficiency, and improves patient care. The enhanced nurse worklist alerts and reminds nurses of hospital policy and treatment protocol, which serves both the nurse and the patient. In another embodiment subtask hyperlinks are also included in a worklist to enable nurse direct pertinent access of on-line policy, treatment procedure or protocol manuals for full explanation of the subtasks. The personalized worklist provided by system 10, including adaptively selected subtasks, is usable in inpatient and ambulatory clinical settings, for example, as well as in other healthcare areas employing treatment procedures and protocols.

FIG. 10 shows a flowchart of a process performed by adaptive healthcare workflow and task management system 10 (FIG. 1). In step 812 following the start at step 811, system 10 stores first and second information in at least one repository 17. A repository of first information and a repository of second information are at least one of, (a) the same repositories and (b) different repositories. The first information indicates clinician tasks and related subtasks for performance by clinicians in providing care services, including a particular care service, to patients. The first information indicates multiple subtasks related to individual tasks and subtasks of an individual task are hierarchically arranged into different categories. The second information indicates experience and qualifications of multiple different clinicians. The experience of a particular clinician comprises at least one of, duration of time of pertinent work experience since the particular clinician qualified, duration of time the particular clinician has worked at a particular healthcare facility and duration of time the particular clinician has worked at a particular care unit at a particular healthcare facility. The qualifications of the particular clinician comprise at least one of, healthcare license status and highest academic level attained.

In step 817 rules processor 15, in response to a particular clinician identifier and data identifying a clinician task to be performed by the particular clinician in providing a particular care service to a patient, employs the first and second information in adaptively determining one or more subtasks related to the clinician task to be indicated to be performed by the particular clinician based on experience and qualifications of the particular clinician. Subtasks comprise ancillary tasks to be performed by a clinician at least one of, as pre-administration preparation, post-administration follow-up and during administration, of a care service to a patient Processor 15 also adaptively determines a category of subtask based on experience and qualifications of the particular clinician. Rules processor 15 determines at least one of, (a) different subtasks and (b) no subtasks, related to the clinician task, to be indicated to be performed by a different clinician having different experience and qualifications than the particular clinician. Rules processor 15 adaptively determines a subtask related to the clinician task to be indicated to be performed by the particular clinician based on duration of time the particular clinician works at a facility at least one of, (a) per day, (b) per week and (c) per month. Processor 15 further adaptively determines whether the subtask related to the clinician task is to be indicated to be performed by the particular clinician by determining whether a time duration representing experience of the particular clinician exceeds at least one time predetermined duration threshold and the qualifications of the particular clinician comprise a particular healthcare license status.

In step 819, workflow processor 39 provides data representing a list of tasks including the one or more subtasks related to the clinician task for performance by the particular clinician. The list of tasks includes subtasks of a determined category of subtasks related to the clinician task for performance by the particular clinician. Workflow engine 41 incorporates the one or more subtasks related to the clinician task in a list of tasks for performance by the particular clinician. Workflow processor 39 (or workflow engine 41) initiates communication of data representing the list of tasks to a destination for access by the particular clinician. An output processor (display processor 26) provides data for reproduction and presentation to the particular clinician indicating subtasks of a determined category of subtasks including a subtask related to the clinician task to be indicated to be performed by the particular clinician. Specifically, display processor 26 provides data representing at least one display image indicating the subtask related to the clinician task in a list of tasks for performance by the particular clinician. The process of FIG. 10 terminates at step 825.

The systems and processes of FIGS. 1-10 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system provides a Nurse s Dynamic Worklist that is a flexible, smart, personalized system for use by a nurse in an acute care or other setting. An adaptively generated worklist is scaled down for an experienced, educated, tenured nurse and is scaled up for a novice, transferred nurse, for example. The system facilitates nursing management and review of individual and department performance and allows for quick view modifications that can show immediate results. The processes and applications may in alternative embodiments, be located on one or more (e.g., distributed) processing devices accessing a network linking the elements of FIG. 1. Further, any of the functions and steps provided in FIGS. 1-10 may be implemented in hardware, software or a combination of both and may reside on one or more processing devices located at any location of a network linking the elements of FIG. 1 or another linked network including the Internet.

What is claimed is:

1. An adaptive healthcare workflow and task management system, comprising:
a repository of first information indicating clinician tasks and related subtasks for performance by a clinician in providing a particular care service to a patient;
a repository of second information indicating experience and qualifications of a plurality of different clinicians;
a rules processor for, in response to a particular clinician identifier and data identifying a clinician task to be performed by said particular clinician in providing a particular care service to a patient, employing said first and second information in adaptively determining a subtask related to said clinician task to be indicated to be performed by said particular clinician based on experience and qualifications of said particular clinician; and
an output processor for providing data for reproduction and presentation to said particular clinician indicating said subtask related to said clinician task to be indicated to be performed by said particular clinician.

2. A system according to claim 1, wherein
said rules processor adaptively, determines said subtask related to said clinician task to be indicated to be performed by said particular clinician and determines at least one of, (a) a different subtask and (b) no subtask, related to said clinician task, to be indicated to be performed by a different clinician having different experience and qualifications than said particular clinician.

3. A system according to claim 1, wherein
said rules processor adaptively, determines a plurality of subtasks related to said clinician task to be indicated to be performed by said particular clinician and determines at least one of, (a) different subtasks and (b) no subtasks, related to said clinician task to be indicated to be performed by a different clinician having different experience and qualifications than said particular clinician.

4. A system according to claim 1, wherein
said rules processor adaptively determines said subtask related to said clinician task to be indicated to be performed by said particular clinician based on duration of time said particular clinician works at a facility at least one of, (a) per day, (b) per week and (c) per month.

5. A system according to claim 1, wherein
said experience of said particular clinician comprises at least one of, (a) duration of time of pertinent work experience since said particular clinician qualified, (b) duration of time said particular clinician has worked at a particular healthcare facility and (c) duration of time said particular clinician has worked at a particular care unit at a particular healthcare facility.

6. A system according to claim 1, wherein
said qualifications of said particular clinician comprise at least one of, (a) healthcare license status and (b) highest academic level attained.

7. A system according to claim 1, wherein
said rules processor adaptively determines whether said subtask related to said clinician task is to be indicated to be performed by said particular clinician by determining whether a time duration representing experience of said particular clinician exceeds at least one time predetermined duration threshold and said qualifications of said particular clinician comprise a particular healthcare license status.

8. A system according to claim 1, wherein
subtasks comprise ancillary tasks to be performed by a clinician at least one of, (a) as pre-administration preparation, (b) post-administration follow-up and (c) during administration, of a care service to a patient

9. A system according to claim 1, wherein
said repository of first information and said repository of second information are at least one of, (a) the same repositories and (b) different repositories.

10. A system according to claim 1, wherein
said first information indicates a plurality of subtasks related to individual tasks and subtasks of an individual task are hierarchically arranged into different categories and
said rules processor adaptively determines a category of subtask based on experience and qualifications of said particular clinician and
said output processor provides data for reproduction and presentation to said particular clinician indicating subtasks of a determined category of subtasks related to said clinician task to be indicated to be performed by said particular clinician.

11. A system according to claim 1, wherein
said output processor comprises a display processor for providing data representing at least one display image indicating said subtask related to said clinician task in a list of tasks for performance by said particular clinician.

12. A system according to claim 1, including
a workflow engine for incorporating said subtask related to said clinician task in a list of tasks for performance by said particular clinician and for initiating communication of data representing said list of tasks to a destination for access by said particular clinician.

13. An adaptive healthcare workflow and task management system, comprising:
a repository of first information indicating clinician tasks and related subtasks for performance by clinicians in providing care services, including a particular care service, to patients;
a repository of second information indicating experience and qualifications of a plurality of different clinicians;
a rules processor for, in response to a particular clinician identifier and data identifying a clinician task to be performed by said particular clinician in providing a particular care service to a patient, employing said first and second information in adaptively determining a plurality of subtasks related to said clinician task to be indicated to be performed by said particular clinician and determines at least one of, (a) different subtasks and (b) no subtasks, related to said clinician task, to be indicated to be performed by a different clinician having different experience and qualifications than said particular clinician; and
a workflow processor for providing data representing a list of tasks including said plurality of subtasks related to said clinician task for performance by said particular clinician and for initiating communication of data representing said list of tasks to a destination for access by said particular clinician.

14. An adaptive healthcare workflow and task management system, comprising:
a repository of first information indicating clinician tasks and related subtasks for performance by clinicians in providing care services, including a particular care service, to patients, and subtasks of an individual task are hierarchically arranged into different categories;
a repository of second information indicating experience and qualifications of a plurality of different clinicians;
a rules processor for, in response to a particular clinician identifier and data identifying a clinician task to be performed by said particular clinician in providing a particular care service to a patient, employing said first and second information in adaptively determining a category of subtask based on experience and qualifications of said particular clinician; and
a workflow processor for providing data representing a list of tasks including subtasks of a determined category of subtasks related to said clinician task for performance by said particular clinician and for initiating communication of data representing said list of tasks to a destination for access by said particular clinician.
